(19) United States
(12) Patent Application Publication
(10) Pub. No.: US 2011/0011934 A1
(43) Pub. Date: Jan. 20, 2011

(54) CONTACTLESS IC CARD AND WIRELESS SYSTEM

(75) Inventors: Tetsuro Iwamura, Kanagawa (JP); Tomoyuki Honma, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/726,476

(22) Filed: Mar. 18, 2010

(30) Foreign Application Priority Data
Jul. 17, 2009 (JP) 2009-169221

(51) Int. Cl. G06K 19/07; G06K 7/00

(52) U.S. Cl. 235/435

(57) ABSTRACT

A contactless IC card includes: an antenna configured to receive an electromagnetic wave and to induce an AC signal; a rectifier circuit configured to rectify an AC signal from the antenna; a demodulating circuit configured to demodulate received data from a rectified signal from the rectifier circuit; a carrier extraction circuit configured to extract a carrier from the AC signal or the rectified signal and to generate an operation clock; a return data generating unit configured to operate at the operation clock from the carrier extraction circuit and, after receiving received data from the demodulating circuit, output return data to a reader-writer; a modulating unit configured to load-modulate the carrier of the AC signal with the return data; and a sensitivity control unit configured to perform control so as to increase carrier extraction sensitivity of the carrier extraction circuit during a return period to the reader-writer.

### CROSS-REFERENCE TO RELATED APPLICATIONS

This application is based upon and claims the benefit of priority from the prior Japanese Patent Application No. 2009-169221 filed in Japan on Jul. 17, 2009; the entire contents of which are incorporated herein by reference.

### BACKGROUND OF THE INVENTION

1. Field of the Invention

The present invention relates to a contactless IC card and a wireless system, and in particular, to a contactless IC card and a wireless system which enable carrier extraction and clock generation to be reliably performed with a contactless IC card or the like to be mounted on a mobile device that performs contactless communication via an electromagnetic field or radio waves.

2. Description of Related Art

IC cards and RF tags are used in various fields as wireless communication means for exchanging information by near-field wireless communication using an electromagnetic field or radio waves (hereinafter, simply referred to as an electromagnetic field).

Contactless IC cards and RF tags which communicate via an electromagnetic field can be divided into passive IC cards and RF tags which obtain power from the electromagnetic field and active IC cards and RF tags which are supplied power from a battery or the like.

Hereinafter, while a contactless IC card among contactless IC cards and RF tags will be described for the sake of simplicity, similar configurations, effects, and advantages can also be achieved by using a contactless RF tag instead of a contactless IC card.

Prior art regarding conventional contactless IC cards include those disclosed in Japanese Patent Application Laid-Open Publication No. 2006-31473, Japanese Patent Application Laid-Open Publication No. 2007-148957, and Japanese Patent Application Laid-Open Publication No. 5-128319.

According to Japanese Patent Application Laid-Open Publication No. 2006-31473, an RFID tag is configured such that a resistor can be inserted between an antenna and an RFID tag IC so as to enable adjustment of receiver sensitivity.

According to Japanese Patent Application Laid-Open Publication No. 2007-148957, a wireless tag information reading apparatus (reader-writer) is arranged such that a threshold of a demodulating circuit can be varied according to command types and noise levels so as to enable adjustment of receiver sensitivity.

According to Japanese Patent Application Laid-Open Publication No. 5-128319, a contactless IC card is arranged such that a capacity of a tuning capacitor inside the contactless IC card can be varied according to an RF level received from a reader-writer so as to enable adjustment of receiver sensitivity.

However, while all three patent documents described above are intended to improve data demodulation by enabling adjustment of receiver sensitivity, the patent documents are not designed to adjust carrier extraction sensitivity in order to improve carrier extraction and clock generation.

### BRIEF SUMMARY OF THE INVENTION

A contactless IC card according to an aspect of the present invention includes: an antenna configured to receive an electromagnetic wave and to induce an AC signal; a rectifier circuit configured to rectify an AC signal from the antenna; a demodulating circuit configured to demodulate received data from a rectified signal from the rectifier circuit; a carrier extraction circuit configured to extract a carrier from the AC signal or the rectified signal and to generate an operation clock; a return data generating unit configured to operate at the operation clock from the carrier extraction circuit and, after receiving received data from the demodulating circuit, generate and output return data to a reader-writer; a modulating unit configured to load-modulate the carrier of the AC signal with the return data; and a sensitivity control unit configured to operate at the operation clock from the carrier extraction circuit and, during a return period to the reader-writer, output a sensitivity control signal and perform control so as to increase a carrier extraction sensitivity of the carrier extraction circuit.

A contactless IC card according to another aspect of the present invention includes: an antenna configured to receive an electromagnetic wave and to induce an AC signal; a rectifier circuit configured to rectify an AC signal from the antenna; a demodulating circuit configured to demodulate received data from a rectified signal from the rectifier circuit; a carrier extraction circuit configured to extract a carrier from the AC signal or the rectified signal and generate an operation clock; a return data generating unit configured to operate at the operation clock from the carrier extraction circuit and, after receiving received data from the demodulating circuit, output return data to a reader-writer; and a modulating unit configured to load-modulate the carrier of the AC signal with the return data, wherein a carrier extraction sensitivity of the carrier extraction circuit is increased during a return period to the reader-writer by supplying return data from the return data generating unit as a sensitivity control signal to the carrier extraction circuit.

A wireless system according to yet another aspect of the present invention includes: a contactless IC card having an antenna configured to receive an electromagnetic wave and induce an AC signal, a rectifier circuit configured to rectify an AC signal from the antenna, a demodulating circuit configured to demodulate received data from a rectified signal from the rectifier circuit, a carrier extraction circuit configured to extract a carrier from the AC signal or the rectified signal and generate an operation clock, a return data generating unit configured to operate at the operation clock from the carrier extraction circuit and, after receiving received data from the demodulating circuit, generate and output return data to a reader-writer, a modulating unit configured to load-modulate the carrier of the AC signal with the return data, and a sensitivity control unit configured to operate at the operation clock from the carrier extraction circuit and, during a return period to the reader-writer, output a sensitivity control signal and perform control so as to increase a carrier extraction sensitivity of the carrier extraction circuit; and a reader-writer having a second antenna and which is configured to read load-modulated return data from the contactless IC card contained in the AC signal.

### BRIEF DESCRIPTION OF THE DRAWINGS

FIG. 1 is a block diagram illustrating a wireless system including a contactless IC card according to a first embodiment of the present invention;

FIG. 2 is a waveform diagram illustrating a state where modulation is applied at a reader-writer and an IC card on a carrier of an AC signal transmitted from the reader-writer;

FIGS. 3A and 3B are diagrams illustrating a modulation signal used for load modulation when replying from an IC card during a data transmission idle period of a reader-writer, and a sensitivity control signal to be supplied to a carrier extraction circuit during load modulation;

FIG. 4 is a circuit diagram illustrating a configuration example of the contactless IC card according to the first embodiment illustrated in FIG. 1;

FIGS. 5A to 5C are timing diagrams describing an operating principle of carrier extraction illustrated in FIG. 4;

FIG. 6 is a timing diagram describing carrier extraction sensitivity switching during load modulation illustrated in FIG. 4;

FIG. 7 is a circuit diagram illustrating another configuration example of the contactless IC card according to the first embodiment illustrated in FIG. 1;

FIG. 8 is a circuit diagram illustrating a configuration of a Schmitt trigger circuit according to FIG. 7;

FIGS. 9A to 9C are timing diagrams describing an operating principle of carrier extraction illustrated in FIGS. 7 and 8;

FIG. 10 is a timing diagram describing carrier extraction sensitivity switching during load modulation illustrated in FIGS. 7 and 8;

FIG. 11 is a block diagram illustrating a wireless system including a contactless IC card according to a second embodiment of the present invention;

FIG. 12 is a block diagram illustrating a wireless system including a general passive IC card;

FIG. 13 is a diagram illustrating an antenna waveform of a carrier from a reader-writer load-modulated by an IC card in the passive IC card illustrated in FIG. 12;

FIG. 14 is a block diagram illustrating a wireless system including a general active IC card; and

FIG. 15 is a diagram illustrating an antenna waveform of a carrier from a reader-writer load-modulated by an IC card in the active IC card illustrated in FIG. 14.

### DETAILED DESCRIPTION OF THE INVENTION

Hereinafter, embodiments of the present invention will be described in detail with reference to the drawings.

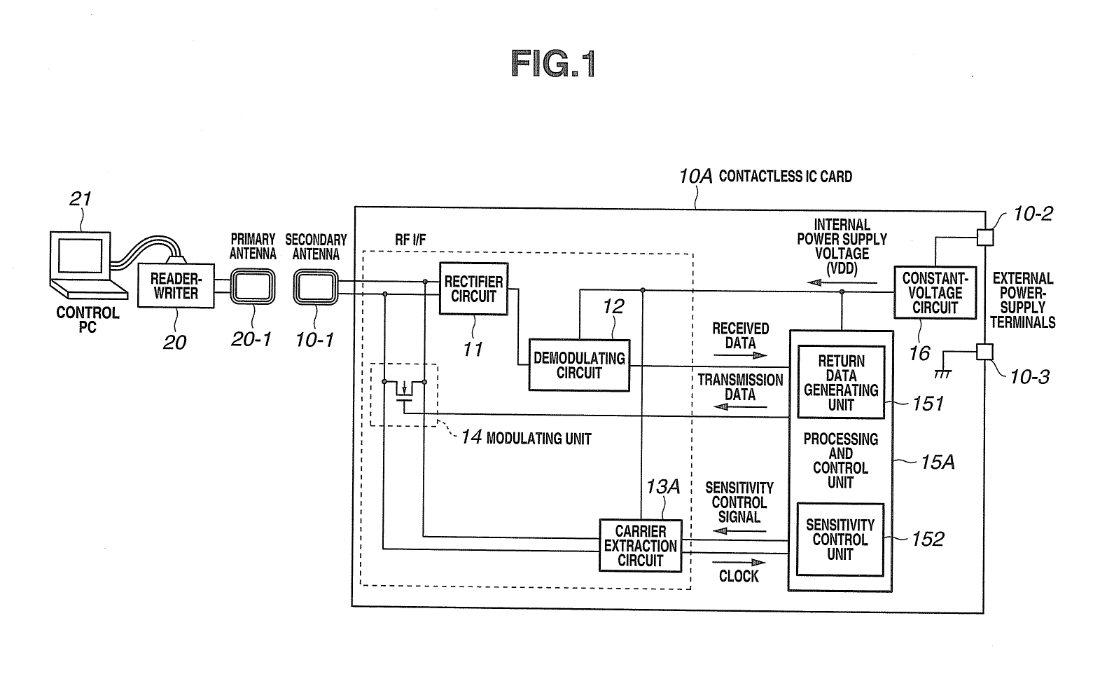

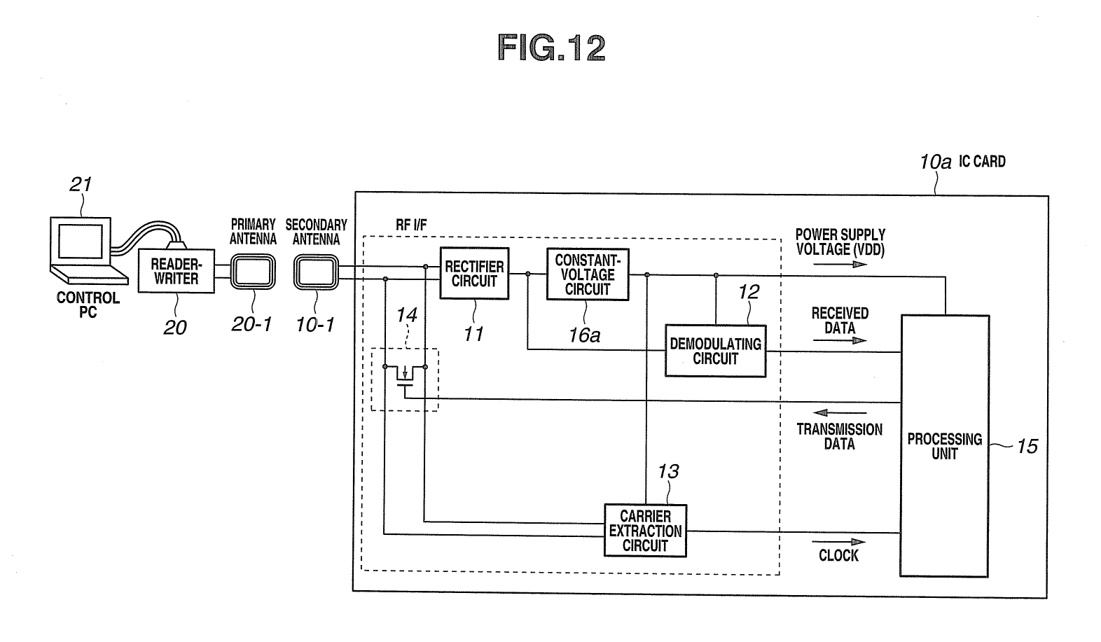

Before describing the embodiments of the present invention with reference to FIGS. 1 to 11, a general contactless IC card and a wireless system will be briefly described with reference to FIGS. 12 to 15.

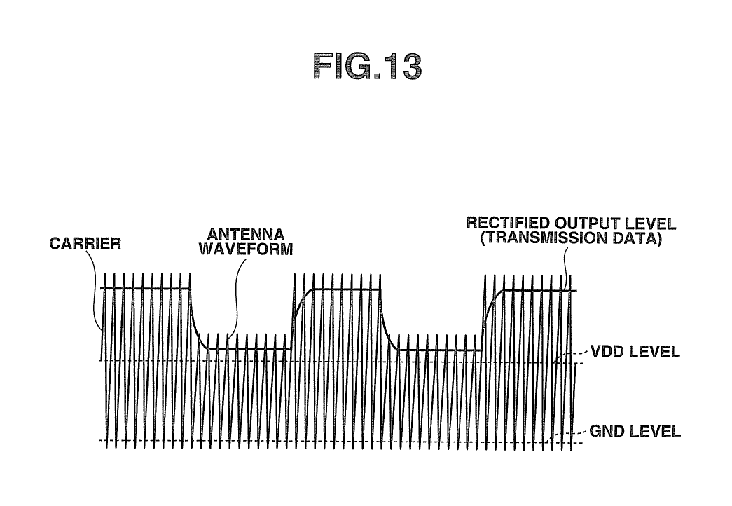

FIGS. 12 and 13 illustrate a wireless system including a general passive contactless IC card. FIG. 12 illustrates a configuration and FIG. 13 illustrates an antenna waveform of a carrier binarily load-modulated by an IC card. As described earlier, an RF tag may be used in place of the IC card.

In FIG. 12, reference character 10a denotes a passive contactless IC card, 11 a rectifier circuit, 12 a demodulating circuit, 13 a carrier extraction circuit, 14 a modulating unit constituted by a load-modulating transistor, 15 a processing unit constituted by a logic and a memory, 16a a constant-voltage circuit, 20 a reader-writer, 21 a control PC (personal computer), 20-1 a primary antenna constituted by a loop antenna, and 10-1 a secondary antenna constituted by a loop antenna.

With the passive contactless IC card illustrated in FIG. 12, a radio-frequency unit (RF I/F) receives an electromagnetic field discharged as a carrier from the loop antenna 20-1 connected to the reader-writer 20 with the loop antenna 10-1, converts the carrier into data, a clock, and power via the rectifier circuit 11, and supplies the same to the processing unit 15 that performs primary processing. The constant-voltage circuit 16a is disposed at a subsequent stage of the rectifier circuit 11 and generates a constant voltage using a rectified voltage obtained by rectifying the received carrier. Therefore, a prerequisite of the operation of the passive contactless IC card 10a is that a carrier voltage amplitude generated at the loop antenna 10-1 equals or exceeds a power-supply voltage (VDD). Accordingly, as illustrated in FIG. 13, a degree of modulation by a modulation signal is set at a depth where a necessary level of the power-supply voltage VDD can be maintained. Exceptionally, a voltage necessary for operations is sometimes obtained by methods such as boosting a rectifier output or using a voltage doubler rectifier circuit as a rectifier circuit. However, such methods are inefficient and therefore are not widely used.

On the other hand, there is a recent trend towards mounting functions of a contactless IC card on mobile devices such as mobile phones. In such device-mounted specifications, active IC cards are employed. This is because in addition to a mobile device including a power supply in the first place, with a passive IC card, metallic portions inside the device affect an electromagnetic field and makes it difficult to obtain power.

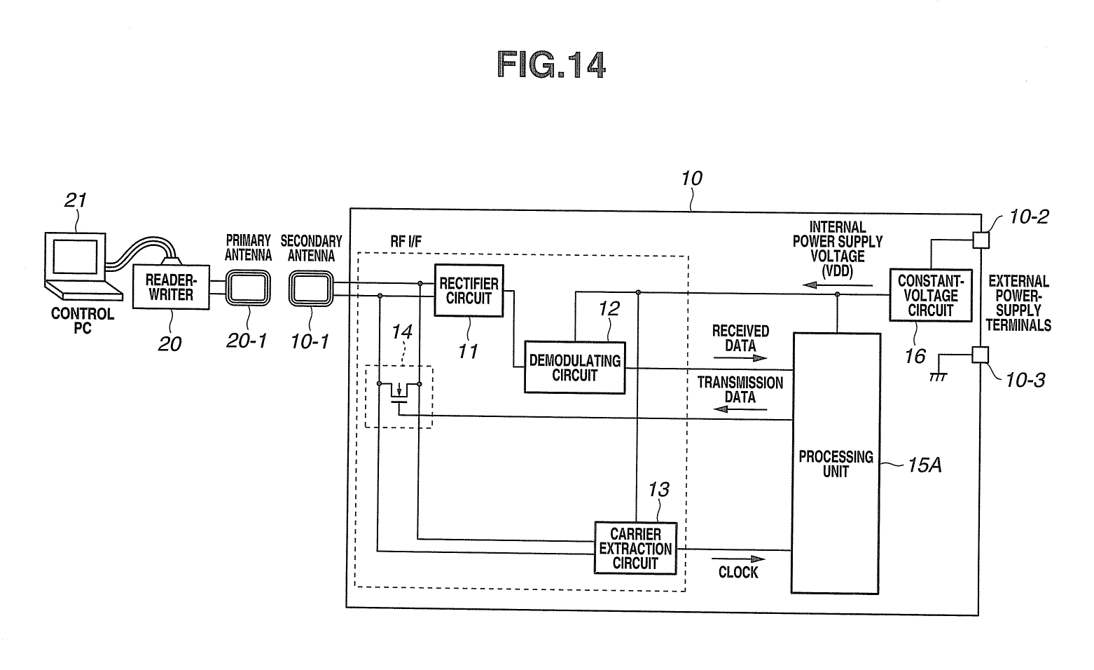

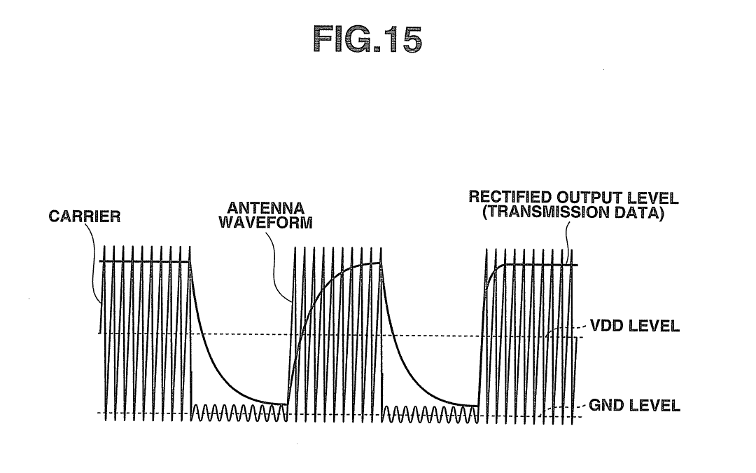

FIGS. 14 and 15 illustrate a mode of a wireless system including a general active IC card. Parts similar to those of FIG. 12 are denoted by similar reference characters. FIG. 14 illustrates a configuration and FIG. 15 illustrates an antenna waveform of a carrier binarily load-modulated by the IC card.

In FIG. 14, reference character 10 denotes a passive contactless IC card, 11 a rectifier circuit, 12 a demodulating circuit, 13 a carrier extraction circuit, 14 a modulating unit constituted by a load-modulating transistor, 15 a processing unit constituted by a logic and a memory, 16 a constant-voltage circuit, 20 a reader-writer, 21 a control PC (personal computer), 20-1 a primary antenna constituted by a loop antenna, 10-1 a secondary antenna constituted by a loop antenna, and 10-2 and 10-3 external power-supply terminals to be connected to an external power supply such as a battery.

With the active contactless IC card 10 illustrated in FIG. 14, since power obtained by the loop antenna 10-1 and the operating power of the circuit portions have a weak direct correlation, favorable communication characteristics can be obtained by improving sensitivity towards data and clocks in terms of circuits. The IC card 10 includes external power-supply terminals 10-2 and 10-3 for connecting an external power supply such as a battery. A degree of modulation by a modulation signal can be increased so as to approach a ground (GND) level as illustrated in FIG. 15. It may be added that by significantly improving extraction sensitivity to data and clocks as compared to passive IC cards, even when the state of an electromagnetic field is inferior, it is possible that superior communication characteristics can be obtained as compared to passive IC cards.

On the other hand, with active contactless IC cards, regardless of how much an IC card's sensitivity is enhanced, communication is not established and communication characteristics cannot be improved unless a reply can be made to a reader-writer. Therefore, it is necessary to enhance the IC card's data demodulation and carrier extraction sensitivity while also improving replying capability.

An IC card uses a load modulation method to reply to a reader-writer. The method involves, in a state where the loop antenna 20-1 of the reader-writer and the loop antenna 10-1 of the IC card are coupled to each other by mutual inductance, varying an impedance of the IC card so as to vary a carrier voltage amplitude generated at the loop antenna 20-1 of the reader-writer. Generally, ASK modulation is adopted in which a modulation of the reader-writer and a load modulation of the IC card both binarily vary carrier amplitude.

Therefore, when having the IC card reply at a more intense level, a greater impedance variation is to take place in correspondence to return data. This means that in a state where impedance drops, a carrier voltage amplitude generated at the IC card loop antenna 10-1 is suppressed and becomes significantly small. Accordingly, as a consequence of a period being generated in which the carrier voltage amplitude is suppressed to a significantly small level for the purpose of further increasing the return level of the IC card, carrier extraction becomes difficult during the return period (i.e., load modulation period). Therefore, it is required that a carrier extraction sensitivity with respect to a carrier voltage amplitude generated at the IC card's loop antenna 10-1 be dramatically improved at least during a load modulation period (return period).

In the following embodiment, an active contactless IC card to be mounted on a mobile device that performs contactless communication via, for example, an electromagnetic field and a wireless system using the active contactless IC card will be described. As described earlier, the embodiment can be similarly applied to an RF tag and a wireless system using the RF tag.

### First Embodiment

FIG. 1 illustrates a wireless system including a contactless IC card according to a first embodiment of the present invention. Parts similar to the active contactless IC card illustrated in FIG. 14 will be described using similar reference characters. The present embodiment can be similarly applied to a wireless system including an active contactless RF tag.

Unlike the contactless IC card 10 illustrated in FIG. 14, a contactless IC card 10A illustrated in FIG. 1 includes a processing and control unit 15A that is the processing unit 15 illustrated in FIG. 14 to which a sensitivity control function has been added. The processing and control unit 15A is constituted by an IC that combines a logic, a memory, and a microcomputer, and is arranged such that a control function carried out by a microcomputer and the like is added onto a processing function including a logic and a memory. Specifically, the processing and control unit 15A includes: a return data generating unit 151 that operates at an operation clock from the carrier extraction circuit 13A, and after receiving received data from the demodulating circuit 12 and deciphering the received data, generates return data to the reader-writer and outputs the return data; and a sensitivity control unit 152 that operates at an operation clock from the carrier extraction circuit 13A, and during a load modulation period corresponding to a return period of an IC card, generates and supplies a sensitivity control signal to the carrier extraction circuit 13A and performs control so as to increase carrier extraction sensitivity of the carrier extraction circuit 13A. During periods other than the load modulation period, the sensitivity control unit 152 performs control so as to lower carrier extraction sensitivity. Actually, carrier extraction sensitivity is controlled during the load modulation period so as to be raised to a second level that is higher than a standard level (first level) that applies to periods other than the load modulation period, and is controlled during periods other than the load modulation period so as to return to the first level.

Therefore, the carrier extraction sensitivity of the carrier extraction circuit 13A is raised or lowered (controlled) by a sensitivity control signal from the processing and control unit 15A. Accordingly, for example, even when carrier amplitude drops during load modulation in an active contactless IC card, carrier extraction can be reliably performed by raising carrier extraction sensitivity and clock generation can always be performed reliably.

The wireless system illustrated in FIG. 1 includes the contactless IC card 10A and a reader-writer 20 connected to a control PC 21 that is a host device.

The reader-writer 20 exchanges data with the contactless IC card 10A. The data exchange between the reader-writer 20 and the contactless IC card 10A is performed in a contactless state respectively via loop antennas 20-1 and 10-1.

The contactless IC card 10A includes: a rectifier circuit 11 connected to the secondary antenna 10-1; a demodulating circuit 12 to which rectifier output is supplied from the rectifier circuit 11; a carrier extraction circuit 13A to which is supplied a same signal as the input of the rectifier circuit 11; a modulating unit 14 constituted by a load-modulating transistor; a processing and control unit 15A having a logic, a memory, and a microcomputer; a constant-voltage circuit 16; and external power-supply terminals 10-2 and 10-3 to which respective positive and negative electrodes of a battery, not shown, are connected. A power-supply voltage from an external power supply such as a battery is supplied to the constant-voltage circuit 16.

The secondary antenna 10-1 receives an electromagnetic wave transmitted from the primary antenna 20-1 connected to the reader-writer 20, whereby an AC signal (for example, an RF signal of 13.56 MHz) is induced and supplied to the rectifier circuit 11. In this case, an AC signal refers to a carrier signal containing data or, in other words, a signal of a carrier modulated by a modulation signal of transmission data of the reader-writer or return data of the IC card, or a signal solely of a non-modulated carrier.

The contactless IC card 10A is not limited to a card-like shape, and box-like, cylindrical, disk-like, stick-like, label-like shapes and the like can be adopted. When mounting on a substrate, for example, the antenna 10-1 is formed so as to enclose the IC card 10A.

The rectifier circuit 11 is constituted by, for example, a full-wave rectifier circuit including a diode bridge, and rectifies an AC signal from the antenna 10-1 and outputs the rectified signal to the demodulating circuit 12.

The carrier extraction circuit 13A extracts a carrier component of an electromagnetic wave transmitted from the reader-writer 20 and generates a clock CLK to be used as an operation clock of the processing and control unit 15A.

An example of operations for generating a clock CLK with the carrier extraction circuit 13A is described in Japanese Patent Application Laid-Open Publication No. 2007-142873, a Japanese Patent Application made by the present applicant.

The constant-voltage circuit 16 voltage-regulates a DC voltage from the external power-supply terminals 10-2 and 10-3 to generate an internal power supply voltage VDD. The generated internal power supply voltage VDD is to be used as an operating voltage of the demodulating circuit 12, the carrier extraction circuit 13A, and the processing and control unit 15A.

The demodulating circuit 12 demodulates received data from an envelope detection voltage of the rectified signal outputted from the rectifier circuit 11 and supplies the demodulated received data to the processing and control unit 15A.

The processing and control unit 15A includes a microprocessor (MPU), a logic circuit (logic), and ROM and RAM memories. The ROM stores a program for executing processing, controls, and the like to be executed at the logic circuit and the MPU. The RAM is used as a storage area and work area of data and the like to be used during program execution processing and control at the logic circuit and the MPU. As described earlier, function-wise, the processing and control unit 15A includes: a return data generating unit 151 that operates at the operation clock from the carrier extraction circuit 13A and outputs return data to a reader-writer; and a sensitivity control unit 152 that operates at the operation clock from the carrier extraction circuit 13A and, during a return period, outputs a sensitivity control signal that performs control so as to increase carrier extraction sensitivity of the carrier extraction circuit 13A.

A load modulation (load switching) method is used when transmitting data (replying) to the reader-writer 20. The load modulation method involves varying the impedance of the loop antenna 10-1 of the IC card 10A in order to increase/decrease the load on the loop antenna 20-1 of the reader-writer 20. Consequently, a variance of a carrier amplitude generated at the loop antenna 20-1 of the reader-writer 20 is to be detected as return data from the IC card 10A.

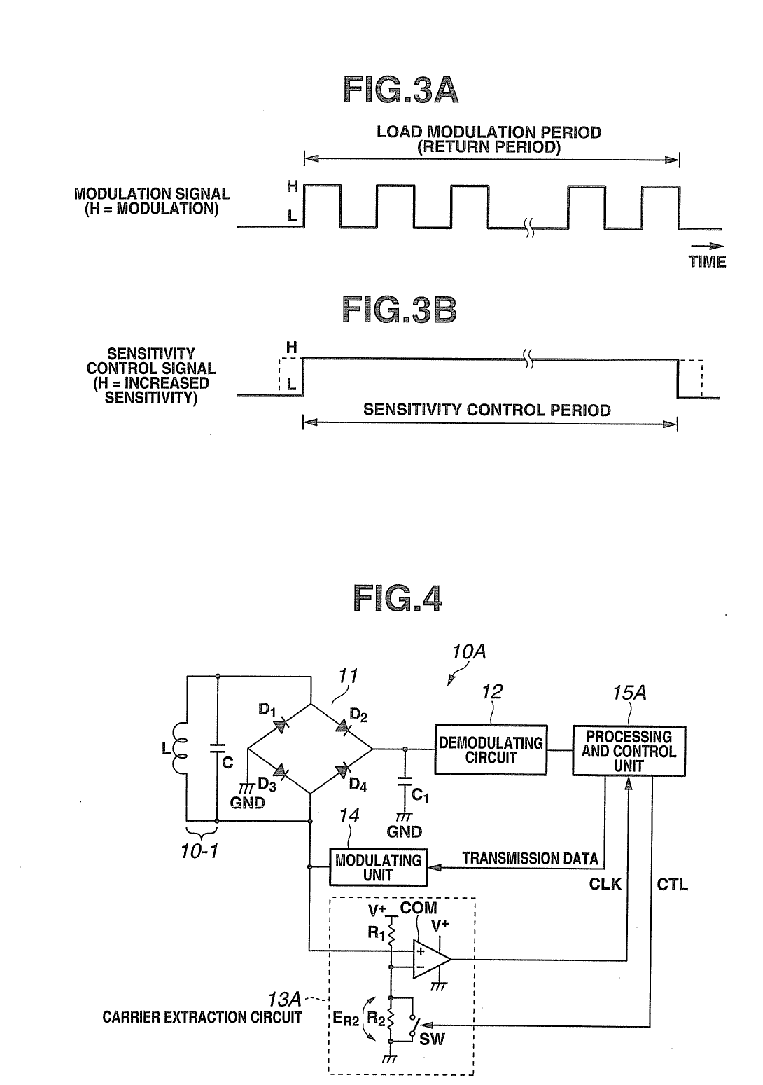

The modulating unit 14 is constituted by, for example, an N-channel MOS transistor that is a load-modulating transistor. A drain of the MOS transistor is connected to one of the lines of an input terminal of the rectifier circuit 11, and a source of the MOS transistor is connected to the other line of the input terminal of the rectifier circuit 11. Transmission data that is to be transmitted from the processing and control unit 15A as return data during a return period to the reader-writer 20 is inputted to a gate of the MOS transistor. Accordingly, when a modulation signal (refer to FIG. 3A) as transmission data to be inputted to the gate of the load-modulating transistor reaches a high level (hereinafter, H level), a resistance value between the two input terminal lines of the rectifier circuit 11 drops significantly. When the modulation signal is at a low level (hereinafter, L level), the resistance between the lines rises, resulting in the carrier during replying being modulated according to transmission data (modulation signal) as illustrated in FIG. 15.

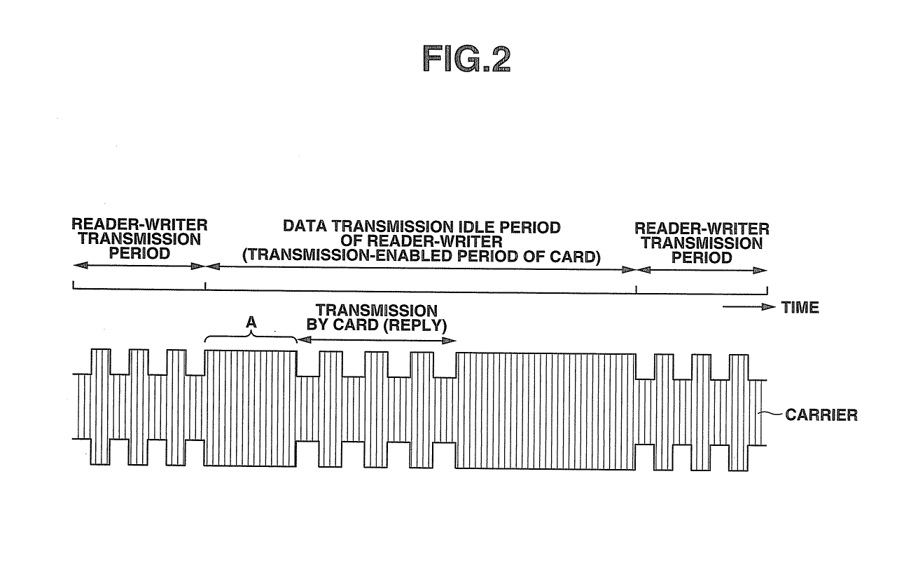

Hereinafter, operations depicted in FIG. 1 will be described with reference to FIGS. 2, 3A, and 3B.

In FIG. 2, a carrier of an AC signal (for example, an RF signal of 13.56 MHz) to be transmitted from the reader-writer is modulated by transmission data during the reader-writer transmission period and transmitted as transmission data from the reader-writer. Only a non-modulated carrier is transmitted from the reader-writer during a data transmission idle period between a transmission period in which transmission data is transmitted from the reader-writer and a next transmission period. During the data idle period, return data is transmitted by load modulation from the IC card. Accordingly, as the communication method, a half-duplex communication method is adopted in which a transmitting side and a receiving side alternate data transmission. However, a non-modulated carrier is constantly being transmitted from the reader-writer. In addition, during a reader-writer transmission period, carrier modulation is performed by transmission data from the reader-writer, and when the antenna of the IC card 10A comes into proximity of the antenna of the reader-writer 20 and enters a state of mutual inductance coupling, carrier modulation (load modulation) is performed by return data from the IC card 10A when entering a data transmission idle period of the reader-writer.

The period indicated by reference character A in FIG. 2 corresponds to a period up to when processing requested to the IC card by transmission data transmitted from the reader-writer 20 during a reader-writer transmission period is completed by the IC card 10A. Upon the end of the period A, the IC card 10A starts transmission of return data by load modulation.

FIGS. 3A and 3B illustrate a timing relation between a start/end of a sensitivity control signal (refer to FIG. 3B) for enhancing sensitivity generated by the sensitivity control unit 152 inside the IC card when transmitting a modulation signal (return data) by load modulation to the reader-writer during a data transmission idle period of the reader-writer illustrated in FIG. 2, and a start/end of a modulation signal (return data) (refer to FIG. 3A). The sensitivity control signal is a control signal that performs control so as to raise carrier extraction sensitivity during a load modulation period (return period of card) and to lower sensitivity (i.e., restore to standard sensitivity) during other periods.

While carrier extraction by a contactless IC card must be constantly performed during all periods, the embodiments of the present invention are arranged so that carrier extraction can be reliably performed through all periods including a load modulation period by raising carrier extraction sensitivity during a load modulation period (return period) in which carrier amplitude may sometimes become suppressed and reduced.

An H level of the modulation signal illustrated in FIG. 3A is a period where a load modulation level is actually applied to a carrier of a certain amplitude. The H-level period corresponds to a period where carrier amplitude as illustrated in FIG. 15 is suppressed to a concave-shape.

While the timing charts in FIGS. 3A and 3B show the start/end timings of a sensitivity control signal for carrier extraction sensitivity and the start/end timings of a modulation signal to be exactly the same, the width of sensitivity control may alternatively be expanded so as to ensure that sensitivity control is to be performed by setting a pulse width of a sensitivity control signal (sensitivity control period illustrated in FIG. 3B) slightly longer than the load modulation period illustrated in FIG. 3A and setting the sensitivity control period temporally wider (depicted by the dotted line in FIG. 3B) than an actual load modulation period.

FIGS. 4 to 6 illustrate a configuration example and an operation example thereof according to the first embodiment.

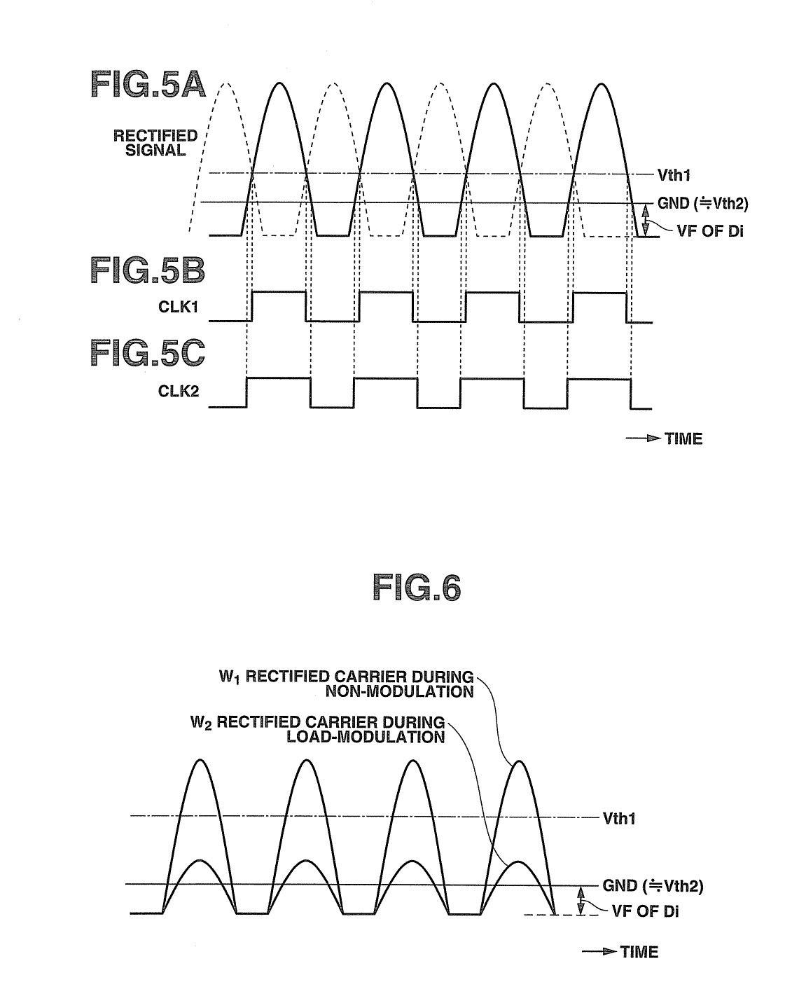

FIG. 4 illustrates a technically characteristic portion according to the present invention and related portions thereof, wherein the external power-supply terminals and the constant-voltage circuit illustrated in FIG. 1 have been omitted. FIG. 5 illustrates a rectified signal and a clock CLK generated by the carrier extraction circuit 13A in correspondence to the configuration example illustrated in FIG. 4. FIG. 6 illustrates a half-wave rectified signal and a threshold Vth1 during non-modulation and a half-wave rectified signal and a threshold Vth2 during load modulation according to FIG. 4.

The antenna 10-1 is constituted by, for example, a parallel resonance circuit including a coil L and a capacitor C. The rectifier circuit 11 is made of, for example, a full-wave rectifier circuit including a diode bridge constituted by first to fourth diodes D1 to D4. A full-wave rectifier output of the rectifier circuit 11 is smoothed by a smoothing capacitor C1 and becomes an envelope detection voltage that is then inputted to the demodulating circuit 12. Received data digitally demodulated at the demodulating circuit 12 is supplied to the processing and control unit 15A.

A half-wave rectified signal outputted from the rectifier circuit 11 is supplied to the carrier extraction circuit 13A. The carrier extraction circuit 13A generates a clock CLK with a same frequency as the carrier frequency by binarizing the rectified signal using a threshold.

The carrier extraction circuit 13A includes: a comparator COM that compares the rectified voltage inputted from the rectifier circuit 11 with a threshold voltage and generates an operation clock with a same frequency as a carrier and; means that switches the threshold according to a sensitivity control signal from the sensitivity control unit 152 in the processing and control unit 15A.

The carrier extraction circuit 13A is constituted by a comparator circuit. The comparator circuit includes: a comparator COM with a non-inverting input terminal (+) into which is inputted a rectified voltage from the rectifier circuit 11 and an inverting input terminal (−) into which is inputted a threshold voltage; a voltage-dividing circuit connected to the inverting input terminal (−) of the comparator COM and which applies a voltage obtained by dividing a voltage r of the voltage supply with resistors R1 and R2 as a threshold to the inverting input terminal (−); and a switch SW connected in parallel to the resistor R2 on a reference potential point GND-side of the voltage-dividing circuit and which opens or short-circuits both ends of the resistor R2. Switching on/off of the switch SW is controlled according to a sensitivity control signal from the processing and control unit 15A. Alternatively, a small resistor may be serially connected to the switch SW.

The processing and control unit 15A is operated at the clock CLK from the carrier extraction circuit 13A, and after bringing the IC card 10A into close proximity of the reader-writer 20 and receiving transmission data from the reader-writer 20 with the antenna 10-1, the processing and control unit 15A functions to transmit transmission data as the return data to the modulating unit 14 and to supply a sensitivity control signal CTL to the carrier extraction circuit 13A.

Hereinafter, operations depicted in FIG. 4 will be described with reference to FIGS. 5A to 5C and 6.

In FIG. 5A, a waveform depicted by the solid line represents a voltage waveform at one of the terminals of the antenna 10-1 or, in other words, a connection point of the diode D3 and the diode D4 of the rectifier circuit 11, while a waveform depicted by the dotted line represents a voltage waveform at the other terminal of the antenna 10-1 or, in other words, a connection point of the diode D1 and the diode D2 of the rectifier circuit 11. The waveform depicted by the dotted line is 180 degrees out of phase from the waveform depicted by the solid line. In addition, in the waveforms illustrated in FIG. 5A, the level at the low potential side is lower than a ground level GND by just a VF (forward breakdown voltage: generally around 0.7 V) of a diode Di.

FIG. 5B illustrates a clock CLK1 generated in a state where a rectified signal illustrated in FIG. 5A is inputted to the non-inverting input terminal (+) of the comparator circuit that constitutes the carrier extraction circuit 13A and a high potential threshold Vth1 is applied to the inverting input terminal (−) as a threshold. In addition, FIG. 5C illustrates a clock CLK2 generated in a state where a rectified signal illustrated in FIG. 5A is inputted to the non-inverting input terminal (+) of the comparator circuit that constitutes the carrier extraction circuit 13A and thresholds are switched so as to apply a low potential threshold Vth2 to the inverting input terminal (−) as a threshold. Compared to when the threshold is Vth1, when the threshold is Vth2, since a wider waveform portion of a half-wave rectified signal (rectified carrier) is to be detected and carrier detection will be performed more reliably, the state corresponds to improved carrier extraction sensitivity.

An electromagnetic wave from the reader-writer 20 is received by the antenna 10-1 and rectified by the rectifier circuit 11, and received data is demodulated by the demodulating circuit 12. At the same time, the rectified signal rectified by the rectifier circuit 11 is sent to the carrier extraction circuit 13A. When the switch SW is in open position, the comparator circuit constituted by the comparator COM compares the rectified signal with the threshold Vth1 and generates a clock CLK1 that sets a rectified signal period exceeding the threshold Vth1 as an H level. The clock CLK1 is a clock whose frequency is the same as the carrier frequency. The demodulated data and the clock CLK1 are sent to the processing and control unit 15A. The processing and control unit 15A judges the demodulated data from the demodulating circuit 12 using the clock CLK1 as the operation clock. After judging that the demodulated data is received data from the reader-writer 20, the processing and control unit 15A generates a sensitivity control signal CTL and supplies the same to the comparator circuit that constitutes the carrier extraction circuit 13A and, at the same time, sends return data prepared in advance in the memory of the processing and control unit 15A to the modulating unit 14 as transmission data.

The sensitivity control signal CTL (refer to FIG. 3B) sent to the carrier extraction circuit 13A is formed with the same or a slightly longer duration as the load modulation period of the modulating unit 14, and switches on the switch SW provided at the carrier extraction circuit 13A during the H-level period of the sensitivity control signal. The activation of the switch SW causes the threshold applied to the inverting input terminal (−) of the comparator COM to drop from Vth1 illustrated in FIG. 5A to the potential of the reference potential point GND or to the threshold Vth2 having a similar potential. The decrease to the threshold Vth2 results in an improvement of carrier extraction sensitivity by the comparator COM. The switching of thresholds approximately simultaneously causes a start of load modulation by the modulating unit 14, and as illustrated in FIG. 6 (and in FIG. 15), the amplitude of a half-wave rectified carrier is suppressed by the load modulation and drops from W1 to W2. Even when carrier amplitude is significantly lowered in this manner, a carrier with the small amplitude can be extracted by using a threshold Vth2 that is the same as (or similar to) the reference potential point GND and a clock CLK2 can be generated as illustrated in FIG. 5C. The clock CLK2 is a clock whose frequency is the same as the carrier frequency.

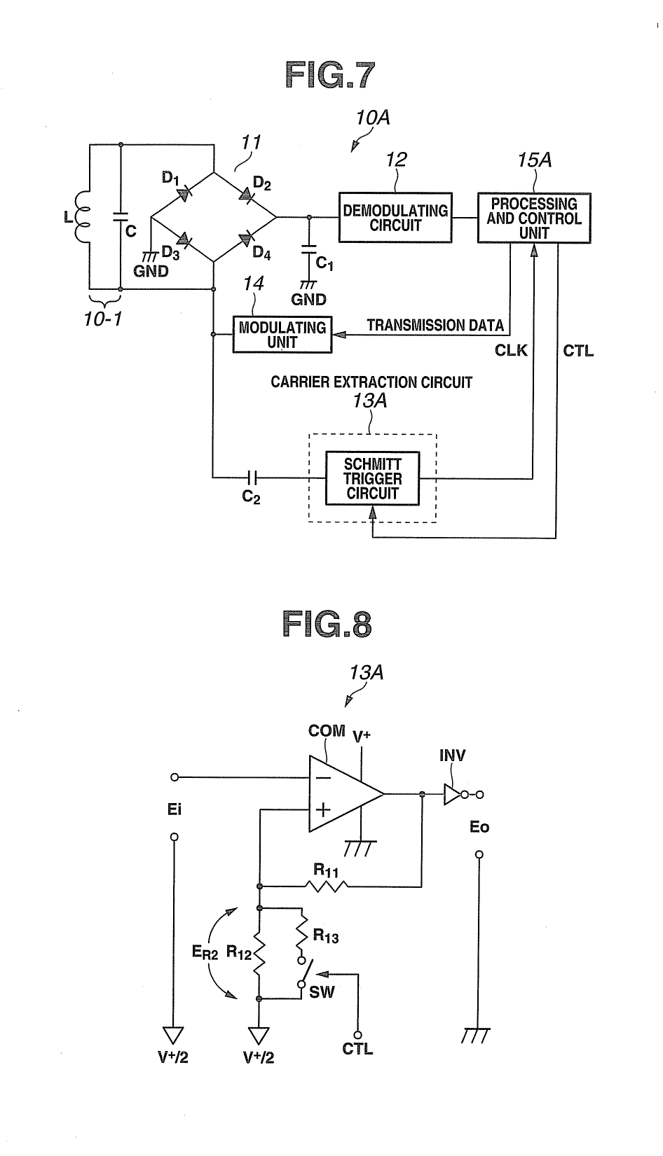

Moreover, at the one of the terminals of the antenna (the connection point of D3 and D4), a carrier waveform denoted by reference character W1 in FIG. 6 is a non-modulated state with a large amplitude and a carrier waveform denoted by reference character W2 is a load-modulated state with a reduced amplitude. In either case, a potential lowered by precisely a forward breakdown voltage VF of a single diode of the diode bridge from the reference potential point GND is used as a reference. Therefore, by shifting thresholds downwards from Vth1 to Vth2, apparent sensitivity will seem to improve. However, this is premised on the carrier extraction circuit 13A not having an input coupling capacitor C2 as illustrated in FIG. 7.

FIGS. 7 to 10 illustrate another configuration example and an operation example thereof according to the first embodiment.

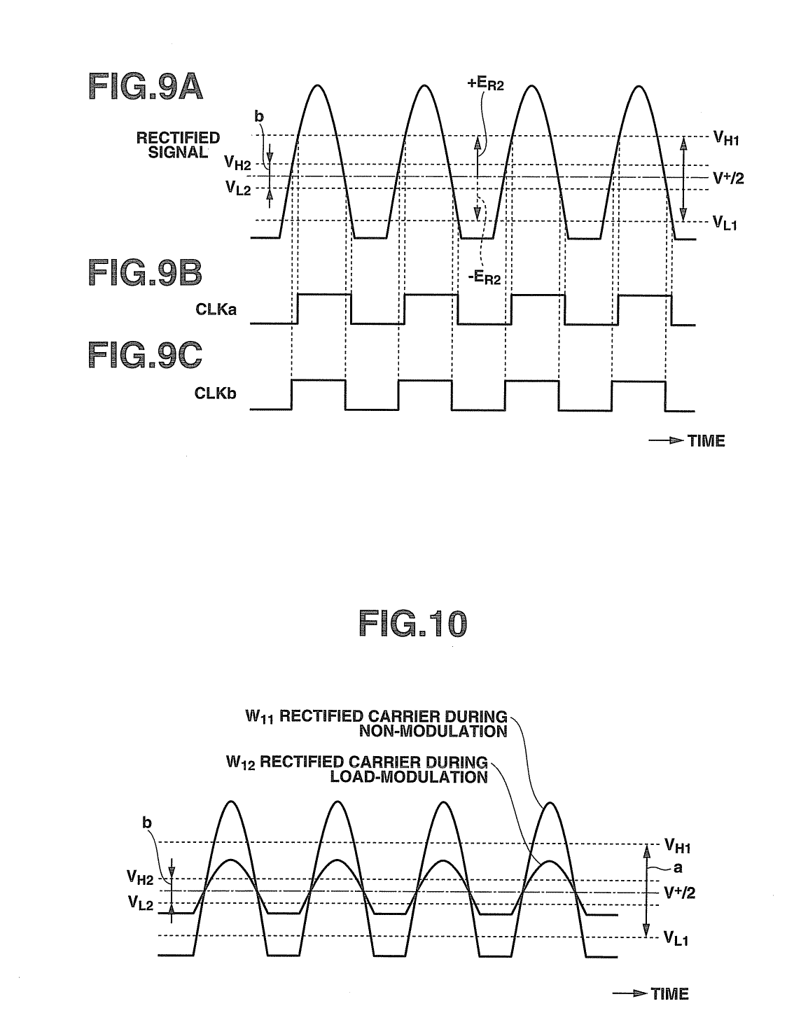

FIG. 7 illustrates a technically characteristic portion according to the present invention and related portions thereof, wherein the external power-supply terminals and the constant-voltage circuit illustrated in FIG. 1 have been omitted. FIG. 8 illustrates a configuration of a Schmitt trigger circuit illustrated in FIG. 7. FIGS. 9A to 9C illustrate a rectified signal and a clock CLK generated by the carrier extraction circuit 13A in correspondence with the configuration example illustrated in FIG. 7. FIG. 10 illustrates a half-wave rectified signal and thresholds VH1 and VL1 during non-modulation and a half-wave rectified signal and thresholds VH2 and VL2 during load-modulation as illustrated in FIG. 7.

The antenna 10-1 is constituted by, for example, a parallel resonance circuit including a coil Land a capacitor C. The rectifier circuit 11 is made of, for example, a full-wave rectifier circuit including a diode bridge constituted by first to fourth diodes D1 to D4. A full-wave rectifier output of the rectifier circuit 11 is smoothed by a smoothing capacitor C1 and becomes an envelope detection voltage that is then inputted to the demodulating circuit 12. Received data digitally demodulated by the demodulating circuit 12 is supplied to the processing and control unit 15A.

A half-wave rectified signal outputted from the rectifier circuit 11 is supplied to the carrier extraction circuit 13A via a DC current cutoff capacitor C2. The carrier extraction circuit 13A is constituted by a Schmitt trigger circuit and compares an inputted half-wave rectified signal with two thresholds that regulate a hysteresis width and binarizes the signal to generate a clock CLK with the same frequency as the carrier frequency.

The carrier extraction circuit 13A includes: a Schmitt trigger circuit having a comparator COM that compares a rectified signal inputted from the rectifier circuit 11 via the DC current cutoff capacitor C2 with two thresholds that regulate a hysteresis width and generates an operation clock with a same frequency as a carrier; and means that switches the hysteresis width corresponding to the difference between the two thresholds according to a sensitivity control signal from the sensitivity control unit 152.

The Schmitt trigger circuit has a characteristic (hysteresis) in which thresholds of the comparator COM differ between when an inputted rectified signal changes from a low potential side to a high potential side (during rising) and when changing from a high potential side to a low potential side (during falling), and enables a hysteresis width (range) corresponding to a difference between the two thresholds to be varied according to an H level and an L level of a sensitivity control signal CTL from the sensitivity control unit 152 in the processing and control unit 15A.

As illustrated in FIG. 8, the Schmitt trigger circuit includes the comparator COM and is arranged such that: an input AC signal (carrier signal) Ei is supplied between an inverting input terminal (−) and a terminal to which a DC bias V⁺/2 is applied; a DC potential V⁺/2 is supplied via the resistor R12 and an output of the comparator COM is supplied via the resistor R11 to the non-inverting input terminal (+); and a switch SW that opens or short-circuits both ends of the resistor R12 or emulates a state where a small resistor that approximates short circuit is connected in parallel is connected to both ends of the resistor R12. In FIG. 8, a DC bias V⁺/2 is applied to the input signal Ei to be inputted between input terminals, and the DC potential V⁺/2 is applied to the GND side of the resistor R12. V⁺/2 applies a median voltage of a power-supply voltage V⁺ of the IC card 10A and GND. Moreover, when logically assimilating the waveform diagrams illustrated in FIGS. 9A to 9C and 10 which describe operations illustrated in FIG. 8, it is required that an inverter INV be inputted to an output terminal of the comparator COM to perform inversion as illustrated in FIG. 8.

In this configuration, if ER2 denotes a voltage generated between both ends of the resistor R12, then the two thresholds VH1 and VL1 of the Schmitt trigger circuit may be expressed as VH1=(V⁺/2)+ER2, VL1=(V⁺/2)−ER2 and the hysteresis width (=VH1−VL1) may be expressed as double the voltage ER2. Therefore, in order to vary hysteresis width (i.e., vary carrier extraction sensitivity), varying the value of the resistor R12 shall suffice. Since an intermediary position of the amplitude of a AC signal with a median potential V⁺/2 as its center is considered to be a midpoint potential V⁺/2, even when the carrier amplitude is suppressed from W11 to W12 during load modulation as illustrated in FIG. 10, the smaller the hysteresis width that is the difference between two thresholds VH2 and VL2 with V⁺/2 as center, the more the two thresholds approximate each other and the thresholds VH2 and VL2 are less likely to fall outside of the amplitude of a carrier signal. Therefore, carrier extraction can even be performed on carriers with small amplitudes (in other words, carrier extraction sensitivity is improved). Conversely, the greater the hysteresis width, the more the two thresholds separate from each other with V⁺/2 as center, and the thresholds are more likely to fall outside of the amplitude of a carrier signal. Therefore, it may be said that sensitivity will decline.

Consequently, with a configuration in which a small resistance-added switch SW to which is serially connected a small resistor R13 is connected in parallel to both ends of the resistor R12 in the Schmitt trigger circuit and both ends of the switch SW are opened or short-circuited, two thresholds (V⁺/2)+ER2 and (V⁺/2)−ER2 exist when both ends of the switch SW are opened and hysteresis has a somewhat broad width expressible as 2×ER2. In addition, when both ends of the switch SW are short-circuited, since the small resistor R13 is connected in parallel, the value of ER2 decreases or, in other words, hysteresis width significantly decreases. Otherwise, if the resistor R13 is near 0, hysteresis width approximates 0 during a short-circuit of the switch SW and a state is entered in which the two thresholds approximate to one threshold that equals the median potential V⁺/2.

Hereinafter, operations depicted in FIGS. 7 and 8 will be described with reference to FIGS. 9A to 9C and 10.

An electromagnetic wave from the reader-writer 20 is received by the antenna 10-1 and full-wave rectified by the rectifier circuit 11, and received data is digitally demodulated by the demodulating circuit 12. At the same time, a rectified half-wave rectified signal from the connection point of the diodes D3 and D4 of the rectifier circuit 11 is sent to the carrier extraction circuit 13A. Although the carrier extraction circuit 13A constituted by the Schmitt trigger circuit is set to a broad hysteresis width when the switch SW is open and assumed to be in a noise-tolerant (less affected by noise) state, carrier extraction sensitivity is not favorable due to the broad hysteresis width. However, the rectified signal is compared with two different thresholds VH1 and VL1, and a clock CLKa (refer to FIG. 9B) is generated which is a binarized pulse in which a high-level rectified signal period exceeding the threshold VH1 is replaced by an H level and a low-level rectified signal period falling below the threshold VL1 is replaced by an L level. The clock CLKa is a clock whose frequency is the same as the carrier frequency.

The aforementioned demodulated data and the clock CLKa are sent to the processing and control unit 15A. The processing and control unit 15A judges the demodulated data using the clock CLKa. After judging that the demodulated data is received data from the reader-writer 20, the processing and control unit 15A arrives at a return period to the reader-writer and generates a sensitivity control signal CTL, and supplies the same to the carrier extraction circuit 13A and sends return data prepared in advance in the memory to the modulating unit 14 as transmission data. By adding the return data as a modulation signal (refer to FIG. 3A) to the gate of the modulating transistor, the modulating unit 14 suppresses the amplitude of the half-wave rectified carrier during an H-level period of the return data from W11 to W12 as illustrated in FIG. 10. The sensitivity control signal CTL (refer to FIG. 3B) sent to the carrier extraction circuit 13A is formed with the same or a slightly longer duration as the load modulation period by the modulating unit 14, and switches on the switch SW provided at the Schmitt trigger circuit that is the carrier extraction circuit 13A during the sensitivity control period thereof. In other words, after receiving the transmission data from the reader-writer and upon completion of processing requested by the transmission data, the processing and control unit 15A sends a sensitivity control signal to the carrier extraction circuit 13A before the start of transmission of the return data by load modulation and switches on the switch SW. In response to the switch SW being switched on, as illustrated in FIG. 10, the hysteresis width applied to the Schmitt trigger circuit that is the carrier extraction circuit 13A is switched from a broad hysteresis width a between the two thresholds VH1 and VL1 to a narrow hysteresis width b between the two thresholds VH2 and VL2. Accordingly, the modulating unit 14 approximately simultaneously starts load modulation, and even when carrier amplitude is significantly lowered by load modulation as illustrated in FIG. 15, a carrier with the small amplitude can be extracted by using the two thresholds VH2 and VL2 that form a narrow hysteresis width and detected as a binarized pulse or, in other words, a clock CLKb (refer to FIG. 9C). Subsequently, the clock CLKb is supplied to the processing and control unit 15A. The clock CLKb has the same frequency as the carrier frequency.

Besides a comparator, the carrier extraction circuit may be constituted by a buffer amplifier or an inverter, whereby carrier extraction sensitivity can be controlled by varying the threshold of the buffer amplifier or the inverter.

The first embodiment described above is an active contactless IC card to which power is supplied from a power supply such as a battery, the active contactless IC card including a carrier extraction circuit 13A that extracts a carrier from an AC voltage induced at an antenna terminal or a rectified voltage thereof and generates an operation clock, wherein the active contactless IC card is capable of improving difficulties in carrier extraction that occur when the IC card performs transmission by load modulation (load switching), thereby improving the sensitivity of the carrier extraction circuit and ensuring that carrier extraction and clock generation are to be performed. In other words, timings at which a contactless IC card performs load modulation is known by the IC card itself, thereby enabling the IC card to readily perform control in which carrier extraction sensitivity is enhanced only during a load modulation period and is reduced during other periods. Moreover, the timings at which a contactless IC card performs load modulation are predetermined periods of the data transmission idle periods from the reader-writer as illustrated in FIG. 2.

However, when performing transmission by load modulation by a contactless IC card in this manner, generally, the following issues may conceivably exist as carrier extraction sensitivity is improved. Firstly, electromagnetic field noises induced by the antenna are inadvertently extracted in addition to a carrier. However, since a loop antenna is used in synchronization with a carrier, a filter effect thereof normally prevents electromagnetic field noise from becoming an issue. Secondly, a transient voltage fluctuation that accompanies logic operations penetrates into a rectifier circuit via a ground GND and appears as noise of an antenna terminal. However, since a carrier voltage amplitude is normally greater than noise, this does not particularly pose a problem. Therefore, even when a return level by load modulation is raised, noise is similarly suppressed during carrier amplitude suppression and erroneous extraction of a carrier due to enhanced sensitivity of the carrier extraction circuit is unlikely to occur. As a result, communication quality can be improved.

According to the first embodiment, when replying to a reader-writer from a contactless IC card, even when raising a return level causes carrier amplitude to drop, carrier extraction sensitivity can be automatically increased so as to ensure that carrier extraction and clock generation are to be performed. This is particularly useful when used in an active contactless IC card or an active contactless RF tag and a wireless system using the same.

### Second Embodiment

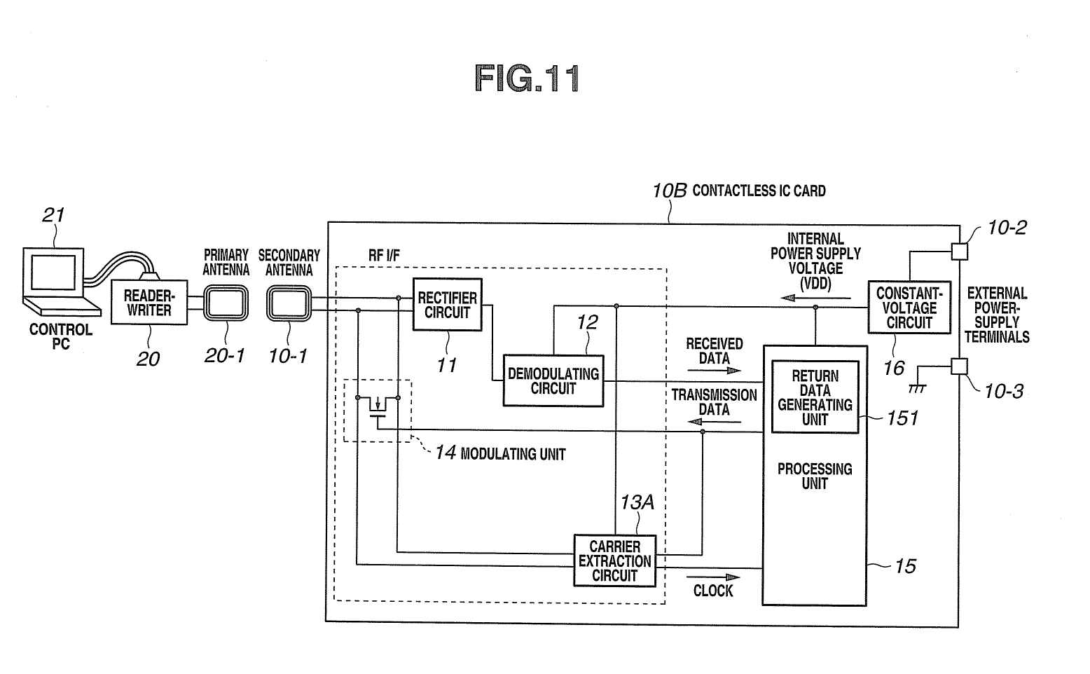

FIG. 11 illustrates a wireless system including a contactless IC card according to a second embodiment of the present invention. The present embodiment can also be similarly applied to a wireless system including an active contactless RF tag.

In a contactless IC card 10B illustrated in FIG. 11, as was the case of FIG. 14, a processing unit 15 does not include sensitivity control functions and only has a return data generating unit 151 as a primary processing function. The difference from the contactless IC card 10 illustrated in FIG. 14 is that by supplying return data sent from the processing unit 15 during a load modulation period to a modulating unit 14 and, at the same time, supplying the return data itself as a sensitivity control signal CTL to a control terminal of a sensitivity switch SW (for example, refer to FIG. 4 or FIG. 8) of a carrier extraction circuit 13A, control is performed so as to raise a carrier extraction sensitivity of the carrier extraction circuit 13A for each transmission symbol of return data during a load modulation period and to lower the carrier extraction sensitivity during periods other than transmission symbols of the load modulation period. In this case, a transmission symbol refers to information of 1 bit or more which can be sent as a single code (a single symbol). In other words, control is performed so as to raise the sensitivity of the carrier extraction circuit 13A during H-level periods of a modulation signal itself in which modulation (refer to FIG. 3A) is applied.

Since return data includes a period (e.g., H-level period) in which modulation is applied to each transmission symbol such as the modulation signal illustrated in FIG. 3A, the carrier extraction sensitivity of the carrier extraction circuit 13A is raised for each H-level period. Accordingly, for example, even when return level is raised during load modulation in an active contactless IC card and carrier amplitude drops as illustrated in FIG. 15, carrier extraction sensitivity improves for each transmission symbol, thereby ensuring that carrier extraction and clock generation are to be performed.

According to the second embodiment, when replying to a reader-writer from an IC card, even when raising a return level causes carrier amplitude to drop, a contactless IC card and a wireless system capable of reliably performing carrier extraction and clock generation can be realized.

According to the embodiments described above, since an erroneous extraction of a carrier due to enhanced sensitivity of the carrier extraction circuit is unlikely to occur even when a return level by load modulation is raised, communication quality can be improved.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A contactless IC card comprising:
an antenna configured to receive an electromagnetic wave and to induce an AC signal;
a rectifier circuit configured to rectify an AC signal from the antenna;
a demodulating circuit configured to demodulate received data from a rectified signal from the rectifier circuit;
a carrier extraction circuit configured to extract a carrier from the AC signal or the rectified signal and to generate an operation clock;
a return data generating unit configured to operate at the operation clock from the carrier extraction circuit and, after receiving received data from the demodulating circuit, output return data to a reader-writer;
a modulating unit configured to load-modulate the carrier of the AC signal with the return data; and
a sensitivity control unit configured to operate at the operation clock from the carrier extraction circuit and, during a return period to the reader-writer, output a sensitivity control signal and perform control so as to increase a carrier extraction sensitivity of the carrier extraction circuit.

2. The contactless IC card according to claim 1, wherein
the sensitivity control unit is configured to perform control so as to raise carrier extraction sensitivity during each return symbol period among the return period.

3. The contactless IC card according to claim 1, wherein
the period in which the carrier extraction sensitivity is controlled is set long so as to exceed a start and an end of the return period or a return symbol period among the return period.

4. The contactless IC card according to claim 1, wherein
the control of carrier extraction sensitivity by the sensitivity control unit is performed by varying a threshold of a comparator, a buffer, or an inverter included in the carrier extraction circuit.

5. The contactless IC card according to claim 1, wherein
the carrier extraction circuit comprises:
a comparator configured to compare a rectified voltage inputted from the rectifier circuit with a threshold voltage and generate an operation clock with a same frequency as a carrier frequency; and
means configured to switch the threshold according to a sensitivity control signal from the sensitivity control unit.

6. The contactless IC card according to claim 1, wherein
the carrier extraction circuit comprises:
a Schmitt trigger circuit having a comparator configured to compare rectified signal inputted from the rectifier circuit via a DC current cutoff capacitor with two thresholds that regulate a hysteresis width and to generate an operation clock with a same frequency as a carrier frequency; and
means configured to switch the hysteresis width corresponding to a difference between the two thresholds according to a sensitivity control signal from the sensitivity control unit.

7. A contactless IC card comprising:
an antenna configured to receive an electromagnetic wave and to induce an AC signal;
a rectifier circuit configured to rectify an AC signal from the antenna;
a demodulating circuit configured to demodulate received data from a rectified signal from the rectifier circuit;
a carrier extraction circuit configured to extract a carrier from the AC signal or the rectified signal and generate an operation clock;
a return data generating unit configured to operate at the operation clock from the carrier extraction circuit and, after receiving received data from the demodulating circuit, output return data to a reader-writer; and
a modulating unit configured to load-modulate the carrier of the AC signal with the return data, wherein
a carrier extraction sensitivity of the carrier extraction circuit is increased during a return period to the reader-writer by supplying return data from the return data generating unit as a sensitivity control signal to the carrier extraction circuit.

8. A wireless system comprising:
a contactless IC card having an antenna configured to receive an electromagnetic wave and induce an AC signal, a rectifier circuit configured to rectify an AC signal from the antenna, a demodulating circuit configured to demodulate received data from a rectified signal from the rectifier circuit, a carrier extraction circuit configured to extract a carrier from the AC signal or the rectified signal and generate an operation clock, a return data generating unit configured to operate at the operation clock from the carrier extraction circuit and, after receiving received data from the demodulating circuit, output return data to a reader-writer, a modulating unit configured to load-modulate the carrier of the AC signal with the return data, and a sensitivity control unit configured to operate at the operation clock from the carrier extraction circuit and, during a return period to the reader-writer, output a sensitivity control signal and perform control so as to increase a carrier extraction sensitivity of the carrier extraction circuit; and
a reader-writer having a second antenna and which is configured to read load-modulated return data from the contactless IC card contained in the AC signal.
